(19) United States
(12) Patent Application Publication
(10) Pub. No.: US 2022/0234266 A1
(43) Pub. Date: Jul. 28, 2022

(54) INJECTION-MOLDED PART AND METHOD FOR PRODUCING THE INJECTION-MOLDED PART

(71) Applicant: Zsófia GUDLIN, ZEBEGENY (HU)

(72) Inventor: Zsófia GUDLIN, ZEBEGENY (HU)

(21) Appl. No.: 17/613,548

(22) PCT Filed: May 21, 2020
(86) PCT No.: PCT/HU2020/000018

§ 371 Date: Nov. 23, 2021

(30) Foreign Application Priority Data
May 24, 2019 (HU) P1900182

(51) Int. Cl. B29C 45/14; B29C 45/16

(52) U.S. Cl. CPC B29C 45/14688; B29C 45/14811; B29C 45/14827; B29K 2703/08; B29C 2045/14696; B29C 2045/14713; B29C 45/1679

(57) ABSTRACT

An injection-moulded piece that has a plastic base layer, a transparent or translucent cover layer, and a layer containing individual decorative elements located between the base and cover layers. The decorative elements are at least partly embedded both in the cover layer and in the base layer. The method for producing the injection-moulded piece, wherein decorative elements are placed on a sticky cover layer and a base layer is applied to the decorative elements by injection moulding. The individual decorative elements are applied to the sticky surface of the cover layer, by a random process, and if required, a second cover layer is applied, the decorative elements are at least partly embedded in the cover layer, waiting for the cover layer to dry, and a base layer is applied to the decorative elements by injection moulding so that the base layer embeds the remaining part of the decorative elements.

The invention relates to an injection-moulded piece and a method for its production. The injection-moulded piece consists of a plastic base layer, at least one preferably transparent or translucent cover layer, and a decorative layer which is arranged between the cover layer and the base layer and which contains decorative elements. The production of the injection-moulded piece can be carried out with such a method in which
decorative elements are applied to the cover layer and
a base layer is applied to the decorative elements by means of plastic injection moulding.

The process can be used for the production of decorative and cladding components for automotive, aircraft and furniture industries, as well as for the design of works of art.

Injection moulding is a known procedure for producing decorative elements for car interiors, during which a decorative layer (for example aluminium, wood veneer, printed decorative film) is inserted in the cavity of a tool. An adhesive layer is laminated onto the inner surface of the decorative layer facing the tool as an adhesion promoter. The base layer of the injection-moulded piece is then formed by injecting a thermoplastic material into the mould cavity. During the injection process, the decorative layer is pressed against the inner surface of the mould cavity and the decorative layer adheres to the base layer through the laminated adhesive layer. In another known variant of the injection moulding process, the decorative layer is pre- formed before being inserted into the injection moulding tool. Using this method, due to the decorative layer, aesthetic components can be produced much more cheaply than would be possible, for example, with metal casting. By the injection moulding process not only contiguous decorative surfaces but also decorative surfaces consisting of several individual decorative elements can be fixed. When using separate decorative elements, it is problematic that the inflowing plastic washes away the decorative elements, as a result of which they become arranged differently and their distribution on the surface is changed. A solution to this problem is offered, for example, in the published document DE 10 2012 016 147 A1, in which a thermoplastic plastic base layer is injected onto a two-layer surface decoration for stiffening purposes. According to the method described here, a second decorative layer consisting of several individual decorative elements is glued onto the first contiguous full-surface decorative layer. The plastic base layer is then injection-moulded onto the first contiguous decorative layer and, if necessary, a cover layer is applied, which serves as a protective layer on the surface of the second decorative layer. However, this solution has the disadvantage that none of the decorative layers is embedded in the injected plastic base layer, so that the decorative layers can easily detach from the base layer due to mechanical stress.

The aim of the invention is to avoid the disadvantages of the prior art and to modify the injection moulding process in such a way that the pattern and design of the decorative layer consisting of several individual decorative elements can be formed as desired immediately before the injection moulding process and that this pattern and/or this design remains unchanged during the injection moulding process.

Another aim of the present invention is to provide an injection-moulded piece and its production method that ensures stronger surface adhesion and a higher bonding force between the individual layers, thereby increasing the load-bearing capacity and the lifespan of the finished injection-moulded piece.

According to the knowledge on which the invention is based, the previously formed decorative pattern on the cover layer remains essentially unchanged during the individual steps of the injection moulding process if sufficient adhesion is achieved between the individual decorative elements forming the decorative layer and the cover layer. If, in addition, the decorative elements of the decorative layer are at least partially embedded in the adjacent layers, the binding forces between the individual layers can be significantly increased.

In accordance with the objective, we start from an injection-moulded piece that has a plastic base layer, preferably a transparent or translucent cover layer, and also a decorative layer consisting of several individual decorative elements and located between the cover layer and the base layer. According to the invention, the decorative elements of the decorative layer are embedded both in the base layer and in the cover layer in the injection-moulded piece. The degree of embedding in the cover layer, based on the size of the mean cross-sectional area of the individual decorative elements, is preferably 1-90%, the remaining part of the decorative elements is embedded in the base layer. With such a structure of the injection-moulded piece it can be ensured that on the one hand, sufficient adhesion is provided between the decorative elements of the decorative layer and the cover layer, so that the originally formed pattern and design remain essentially unchanged during the injection moulding process. On the other hand, since the decorative elements of the decorative layer are at least partly embedded in the cover layer and the base layer and this significantly increases the bonding force between the individual layers, the load-bearing capacity and the lifespan of the product is guaranteed during its use even when mechanical stresses occur.

In a preferred embodiment of the injection-moulded piece according to the invention, the cover layer consists of thermosetting plastic, which has an adhesive surface that secures the position of the decorative elements before hardening. The decorative elements can be applied to the cover layer having the adhesive surface according to a predetermined pattern or in a random pattern (for example by sprinkling on). Because of the sticky surface of the cover layer, the arrangement of the decorative elements remains unchanged during the steps of the injection moulding process.

In another possible embodiment of the injection-moulded piece produced according to the present invention, the cover layer contains a transparent or translucent outer load-bearing plastic layer, on the inner surface of which that faces the decorative elements, a thermosetting plastic layer is applied, which serves as an adhesive layer to fix the position of the decorative elements before curing.

In a further possible embodiment of the injection-moulded piece produced according to the present invention, the unit consisting of the base layer, the layer with the decorative elements and the cover layer is combined with a second identical multi-layer unit, wherein the outer base layer is made of transparent or translucent plastic.

In the injection-moulded piece produced according to the invention, the base layer and the cover layer forming the adhesive layer are formed from thermoplastic or thermosetting plastic. In order to increase the wear resistance of the cover layer that forms the outer layer, it is preferred to use a thermosetting plastic.

In the injection-moulded piece produced according to the invention, the decorative elements are formed from waste products and/or from natural materials.

According to the invention, we start from a method suitable for the production of injection-moulded pieces, in which the decorative elements are applied to a cover layer and the base layer is applied to the decorative elements by injection moulding.

In the method according to the invention
individual decorative elements are applied to a cover layer with a sticky surface,
the decorative elements are embedded in the cover layer with an embedding degree of preferably 1 to 90% based on the size of the mean cross-sectional area of the individual decorative elements,
wait for the sticky cover layer to dry,
the base layer is applied to the decorative elements by injection moulding so that it embeds the remaining part of the decorative elements. The degree of embedding in the base layer, based on the size of the decorative elements, is preferably 99-10%.

In the method according to the invention, waste products and/or natural materials are used as decorative elements. The decorative elements are applied to the cover layer, which is used as an adhesive layer, according to a predetermined pattern or in a random pattern, for example by means of sprinkling. This arrangement remains substantially unchanged during the injection moulding process due to the adhesive strength of the cover layer, in particular after it has been cured.

In a preferred variant of the method according to the invention, the cover layer with the sticky surface is applied to a carrier layer which has previously been pre-formed in accordance with the shape of the injection moulding tool. This pre-formed carrier layer has the shape of the outer surface of the finished injection-moulded piece. In the case of a plastic carrier layer, it is preferred to use a transparent or translucent plastic in order to ensure the visibility of the decorative elements.

In a further possible variant of the method according to the invention, a carrier layer made of metal is used, which is separated from the injection-moulded piece after the injection moulding process. An aluminium carrier layer is preferably used as the metal carrier layer because of its easy deformability. This carrier layer is formed from a metal sheet, for example by cold forming, but any other known forming process can be used.

In a further possible variant of the method according to the invention, the adhesive cover layer is applied to a—preferably lower—inner surface of the injection moulding tool.

In a further preferred variant of the method according to the invention, an outer carrier layer made of plastic is used, on the inner surface of which that faces the decorative elements, a thermosetting plastic is applied, which serves as a sticky surface for fixing the decorative elements before curing.

In a further possible variant of the method according to the invention, the multilayer structure consisting of a base layer, an intermediate layer with decorative elements and a cover layer is combined with a second identically constructed multilayer structure and thus a multilayer design is formed, the outer base layer of which is made of transparent or translucent plastic. dr

In the following, the injection-moulded piece of the present invention and the method for producing the injection-moulded piece are described with reference to exemplary embodiments shown in the drawings.

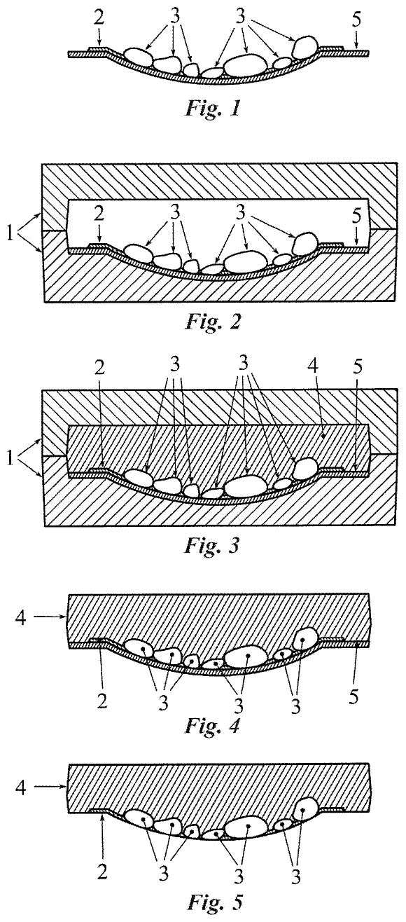

FIG. 1 shows, in a sectional view, the cover layer 2 with an adhesive surface applied to a carrier layer 5, on which adhesive surface the decorative elements 3 are arranged,

FIG. 2 also shows, in a sectional view, the arrangement according to FIG. 1, which is inserted into the lower half of a two-part injection moulding tool 1,

FIG. 3 shows the arrangement having a base layer 4 according to FIG. 2 after injection moulding,

FIG. 4 shows the injection-moulded piece with the carrier layer 5, after its removal from the tool,

FIG. 5 shows the injection-moulded piece according to FIG. 4 after the carrier layer 5 has been removed,

FIG. 6 shows, in a cross-sectional view, the cover layer 2 with a sticky surface applied to the lower half of the two-part injection moulding tool 1, on which sticky surface the decorative elements 3 are arranged,

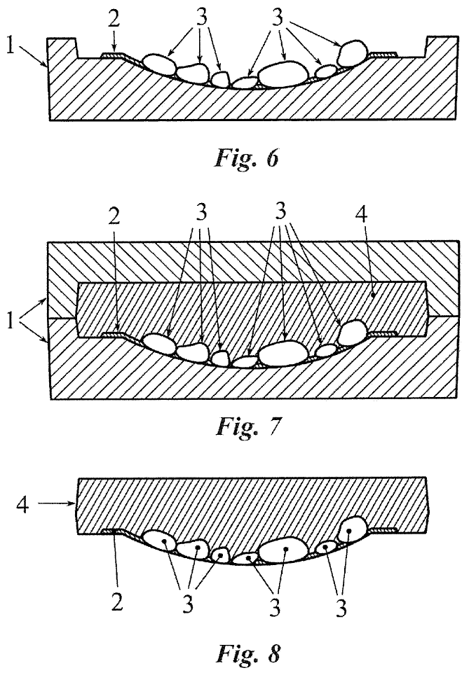

FIG. 7 shows the arrangement having the base layer 4 according to FIG. 6 after injection moulding,

FIG. 8 shows the injection-moulded piece with the cover layer 2, the decorative elements 3, and the base layer 4 after removal from the tool.

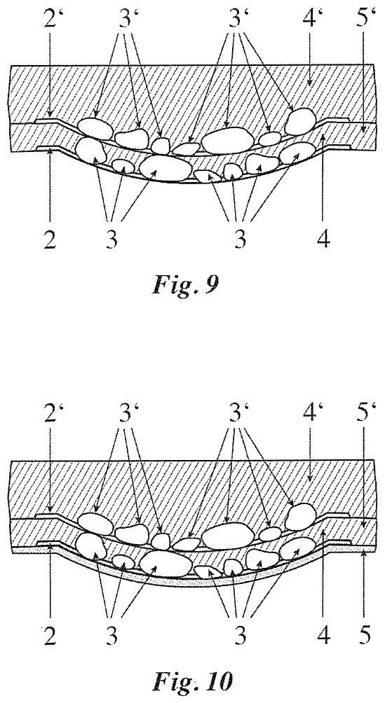

FIG. 9 shows the injection-moulded piece with a cover layer 2, decorative elements 3, a transparent or translucent base layer 4 as a carrier layer 5′ for a further cover layer 2′, a further layer 3′ with decorative elements, and a further base layer 4′ after removal from the tool.

FIG. 10 shows the injection-moulded piece removed from the tool with a carrier layer 5 made of transparent or translucent plastic, a cover layer 2, decorative elements 3, a transparent or translucent base layer 4 as a carrier layer 5′ for another cover layer 2′, a further layer with decorative elements 3′, and a further base layer 4′.

FIGS. 1-5 show, in cross section, the essential steps of the possible variations of the method according to the invention with a carrier layer 5. FIGS. 6-8 show, in cross section, the essential steps of a further possible embodiment, wherein the decorative elements 3 are located directly on the inner surface of the lower half of the injection moulding tool 1. In order to achieve the required adhesion, this inner surface of the tool is provided with a sticky cover layer 2.

FIG. 1 shows the adhesive cover layer 2 applied to the carrier layer 5 and the decorative elements 3 which are fixed on the carrier layer 5 by the adhesive cover layer 2. The cover layer 2 may be made of, for example, thermosetting plastic, which is liquid before being applied to the carrier layer and thus easy to process. The decorative elements 3, which can consist of waste products, natural materials or other relatively small, regularly or irregularly shaped elements, can be applied to the cover layer 2 according to either a predetermined pattern or randomly, for example by sprinkling. The size of the decorative elements 3 is preferably between 1 and 10 mm, preferably between 2 and 8 mm, or preferably between 3 and 6 mm The decorative elements 3 are embedded in the cover layer 2, the degree of embedding in the cover layer 2, based on the size of the mean cross-sectional area of the individual decorative elements 3, preferably being 1-90%. The thickness of the cover layer 2 is preferably between 0.1 mm and 5 mm, preferably between 0.2 and 3 mm and preferably between 0.5 and 2 mm

After the decorative elements 3 have been placed on the essentially liquid or at least spreadable sticky cover layer 2 and if necessary, a further sticky cover layer is applied, the drying of the cover layer 2, i.e. the formation of the glued bond between the decorative elements 3 and the cover layer 2, is awaited.

Then the carrier layer 5 with the cover layer 2 and the decorative elements 3 is inserted into the injection moulding tool, preferably into its lower half, as shown in FIG. 2. After the two mould halves have been closed, it is possible to fill the cavity of the mould 1 with the base layer 4 made of plastic using the injection moulding process. FIG. 3 shows the state in the injection moulding tool 1 after the injection moulding process. The base layer 4 is preferably made of thermoplastic plastic, which is preferably not transparent or translucent, but rather a coloured plastic or a plastic that is coloured in its base material. The colour of the decorative elements 3 and the base layer 4 are preferably different, but they can be selected as desired according to the appearance of the decorative surface to be achieved. FIG. 4 shows the finished injection-moulded piece after it has been removed from the tool, which differs from the arrangement shown in FIG. 1 in that the decorative elements 3 are also embedded in the base layer 4. In this Figure, the base layer 4 is shown above the decorative elements 3, whereas in the built-in position of the pieces, the base layer is on the non-visible rear side of the pieces.

The remaining part of the decorative elements 3 is embedded in the base layer 4 since its layer thickness corresponds to at least to the greatest thickness of the decorative elements 3. The decorative elements are also embedded in the base layer 4, so that the degree of embedding, based on the largest dimension of the decorative elements 3, is preferably between 99% and 10%.

In the event that the carrier layer 5 consists of a metal sheet (e.g. aluminium), the carrier layer 5 is preferably removed after the injection-moulded piece has been removed from the tool 1, so that the carrier layer 5 does not remain a component of the injection-moulded piece. After the carrier layer 5 has been removed, the cover layer made of a transparent or translucent material, the underlying decorative layer of the decorative elements 3 and, behind it, the base layer 4 become visible, as shown in FIG. 5. In order to optimize the haptic and aesthetic effect, it is subsequently possible to grind and/or polish the surface of the cover layer 2 and, if necessary, to paint it. With the grinding it is possible to at least partially remove the cover layer 2. With the complete removal of the cover layer 2, the decorative elements 3 are exposed and are directly tactile and visible. After the cover layer has been completely removed, it is advisable to cover the decorative elements 3 with an aesthetic or protective lacquer layer.

In the event that the carrier layer 5 is a pre-formed plastic carrier layer, preferably consisting of a transparent or translucent material, it is not necessary to remove the carrier layer 5 from the injection-moulded piece after it has been removed from the tool 1. In this case, the carrier layer 5, together with the cover layer 2, which secures the decorative elements 3, and the base layer 4, which embeds the decorative elements 3 on its back side, forms a component of the injection-moulded product. Such a carrier layer can optionally also be identical to the design of the injection-moulded piece shown in FIGS. 4 and 5, in which case we obtain a multi-layer injection-moulded product, as shown in FIGS. 9 and 10.

In another variant of the method according to the invention, the cover layer 2 is not applied to a carrier layer 5, but rather directly applied to the inner surface of the lower half of the injection moulding tool 1, as shown in FIG. 6. The decorative elements 3 can be placed on the cover layer 2 in the same way as shown in FIG. 1, so it will not be described in detail again. FIG. 7 shows the injection moulding tool 1 with the finished piece consisting of the cover layer 2 with an adhesive surface or substance, the decorative layer with the decorative elements 3 and the base layer 4, which is formed in the cavity of the tool 1 by injection moulding. FIG. 8 shows the finished injection-moulded piece after it has been removed from the injection-moulding tool 1. Since no carrier layer 5 is used in this process variant, it does not have to be removed or it is not part of the injection-moulded product.

It is also possible to form an injection-moulded piece in which the injection-moulded product according to FIG. 4 or 5 is combined with the injection-moulded product according to FIG. 8 by superimposing one on the other by injection moulding. In the design of such a multi-layer injection-moulded piece, the base layer facing the visible side preferably also consists of a transparent or translucent material. With such an arrangement and a suitable choice of material, two or even more layers with decorative elements 3 are visible one behind the other, as shown in FIGS. 9 and 10.

The injection-moulded piece shown in FIG. 5 has a plastic base layer 4, a preferably transparent or translucent cover layer 2 and a decorative layer consisting of the decorative elements 3 arranged between the base layer 4 and the cover layer 2, wherein the intermediate layer with the decorative elements 3 is at least partly embedded in the base layer 4 and the cover layer 2. The degree of embedding in the base layer, based on the thickness of the decorative elements, is preferably 10-99%, the remaining part of the decorative elements 3 is embedded in the base layer. Accordingly, the degree of embedding in the cover layer, based on the largest dimension of the decorative elements, is preferably 90-1%.

The cover layer 2 is, for example, a layer made of a thermosetting plastic which, before curing, has a sticky surface that fixes the position of the decorative elements 3, or it is entirely made of an adhesive material, such as a glue.

In the injection-moulded piece shown in FIG. 4, the cover layer 2 includes a transparent or translucent outer plastic carrier layer 5, on the inner surface of which that faces the decorative elements 3, a thermosetting plastic is applied, which has a sticky surface that fixes the position of the decorative elements 3 before curing or it is entirely made of an adhesive material, such as a glue.

The injection-moulded piece in FIG. 5 can be combined with itself or with the injection-moulded piece shown in FIG. 4 in order to thus produce a multi-layer injection-moulded piece. This consists of at least two units, each unit containing at least one base layer 4 or 4′, a decorative layer with decorative elements 3 or 3′ and a cover layer 4 or 4′, the outer base layer 4 being made of a transparent or translucent plastic (see FIGS. 9 and 10.).

The base layer is made of, for example, a thermoplastic material, and the cover layer 2, which forms the adhesive layer, is preferably made of a thermosetting plastic.

The decorative elements 3 can be waste materials or natural materials. Waste materials that may be used include, but are not limited to: waste from manufacturing processes: wood chips, metal shavings, metal splinters, plastic waste, paper scraps, carbon, glass or basalt fibres, textile scraps, metal foil scraps, paint scraps. Usable natural materials may be, for example, but not limited to: gravel, snail shell, mussel, fruit bowl, wood, minerals. The arrangement of the decorative elements 3 may be freely designed according to the decorative appearance to be achieved.

In a possible variant of the method according to the invention for producing an injection-moulded piece, the method steps are as follows:

a) a carrier layer 5 is produced from a metal sheet by cold forming,

b) the carrier layer 5 is inserted into the lower part of an injection moulding tool 1,

c) the cover layer 2 is applied to the carrier layer 5,

d) the decorative elements 3 are sprinkled onto the cover layer 2,

e) waiting for the sticky cover layer 2 to dry,

f) the halves of the injection moulding tool 1 are joined together and the injection moulding tool 1 is closed,

g) the base layer 4 is formed in the mould cavity by injection moulding,

h) the mould 1 is opened and the injection-moulded piece is removed,

i) the carrier layer 5 is separated from the injection-moulded piece.

As an additional step, the surface of the exposed cover layer 2 can be processed as required. Process step b) specified in the example may also be used after process step d). Process step c) may be repeated if necessary for sufficient adhesion of the decorative elements 3 after step d).

In a further possible variant of the process according to the invention for producing an injection-moulded piece, the process steps are as follows:

a) a carrier layer 5 is produced from a transparent or translucent plastic,

b) the carrier layer 5 is inserted into the lower part of an injection moulding tool 1,

c) the cover layer 2 is applied to the carrier layer 5,

d) the decorative elements 3 are sprinkled onto the cover layer 2,

e) waiting for the sticky cover layer 2 to dry,

f) the halves of the injection moulding tool 1 are joined together and the injection moulding tool 1 is closed,

g) the base layer 4 is formed in the mould cavity by injection moulding,

h) the mould 1 is opened and the injection-moulded piece is removed,

In this variant, the carrier layer 5 is not separated from the finished injection-moulded piece since it forms part of the product. Process step b) specified in the example may optionally also be carried out after process step d). The process step c) may be repeated if necessary for sufficient adhesion of the decorative elements 3 after step d).

In a further preferred variant of the method according to the invention for producing an injection-moulded piece, the method steps are as follows:

a) The cover layer 2 is applied to the inner surface of the lower part of the injection moulding tool 1,

b) the decorative elements 3 are sprinkled onto the cover layer 2,

c) waiting for the sticky cover layer 2 to dry,

d) the halves of the injection moulding tool 1 are joined together and the injection moulding tool 1 is closed,

e) the base layer 4 is formed by injection moulding in the tool cavity,

f) the tool 1 is opened and the injection-moulded piece is removed.

As an additional step, the surface of the exposed cover layer 2 may be processed as required. Process step a) may be repeated if necessary for sufficient adhesion of the decorative elements 3 after step b).

In each example of the method, the cover layer 2 comprises a transparent or translucent, thermosetting plastic with an adhesive surface.

The advantage of the injection-moulded piece according to the invention is that the decorative elements 3 embedded in the cover layer 2 and base layer 4 can be connected to one another with high strength, which prevents the decorative elements 3 from shifting or getting rearranged during injection moulding, and for the finished product a high load-bearing capacity is guaranteed during assembly and/or the use of the component.

The process can be carried out in many variants, which considerably increases the number of possible product variants. It is also possible to use not only one-component, but also two- or multi-component injection moulding processes.

Terms used:

1 injection mould

2, 2′ cover layer (with sticky surface)

3, 3′ decorative elements

4, 4′ base layer

5, 5′ carrier layer

1-15. (canceled)

16. A method for producing an injection-moulded part, comprising
a) providing a carrier layer pre-formed according to a shape of an injection moulding tool;
b) applying a hardening, sticky cover layer to one side of the carrier layer;
c) applying a plurality of individual decorative elements to the cover layer by sprinkling, whereby the decorative elements are at least partly embedded in the cover layer;
d) hardening the cover layer, whereby the decorative elements are fixed on the carrier layer;
e) in the injection moulding tool, applying a base layer to the side of the cover layer opposite to the carrier layer;
f) removing the carrier layer from the finished product consisting of the base layer, the decorative elements and the cover layer, a decorative surface being exposed on the outer side of the injection-moulded piece.

17. The method of claim 16, wherein the pre-formed carrier layer is made from sheet metal or plastic.

18. The method of claim 16, wherein the cover layer consists of hardening plastic or hardening adhesive.

19. The method of claim 16, wherein the cover layer consists of transparent or translucent plastic.

20. The method of claim 16, wherein in a further process step, the exposed cover layer of the finished product is processed, preferably by grinding or polishing.

21. The method of claim 16, wherein the decorative surface is covered with a layer of lacquer.

22. The method of claim 16, wherein the decorative elements are made from waste products and natural materials.

23. The method of claim 16, wherein the decorative elements are selected from the following group of materials: wood chips, metal shavings, metal splinters, plastic waste, paper scraps, carbon, glass or basalt fibres, textile scraps, metal foil scraps, paint scraps or usable natural materials, for example gravel, snail shell, mussel, fruit bowl, wood, minerals.

24. The method of claim 16, wherein a multi-layer design comprising a base layer, an intermediate layer with decorative elements and a cover layer, and a second multi-layer design comprising likewise a base layer, an intermediate layer with decorative elements and a cover layer is formed, wherein the outer base layer is made of transparent or translucent plastic.

25. An injection-moulded piece with a decorative surface, consisting of a plastic base layer produced by injection moulding, a cover layer located on one side of the base layer and a plurality of decorative elements between said layers and embedded in both layers, wherein the decorative elements are distributed in a random arrangement, and on an outer side of the injection-moulded piece, the decorative elements and the cover layer together form a decorative surface.

26. The injection-moulded piece of claim 25, characterized in that the cover layer is made of transparent or translucent material.

27. The injection-moulded piece of claim 25, wherein the decorative elements are made from waste products and natural materials.

28. The injection-moulded piece of claim 25, wherein the decorative elements are selected from the following group of materials: wood chips, metal shavings, metal splinters, plastic waste, paper scraps, carbon, glass or basalt fibres, textile scraps, metal foil scraps, paint scraps or usable natural materials, for example gravel, snail shell, mussel, fruit bowl, wood, minerals.

29. The injection-moulded piece of claim 25, wherein a multi-layer structure comprising a base layer, an intermediate layer with decorative elements and a cover layer, and a second structure comprising a base layer, an intermediate layer with decorative elements and a cover layer is formed, the outer base layer being made of transparent or translucent plastic.

30. The injection-moulded piece of claim 25, wherein the decorative surface is covered with a layer of lacquer.
